(19) United States
(12) Patent Application Publication
(10) Pub. No.: US 2004/0060929 A1
(43) Pub. Date: Apr. 1, 2004

(54) Microwave energy novelty or indication device

(76) Inventors: Jeremy Steven Branson, Springfield, VA (US); Mark Maurice Crain, Georgetown, IN (US); Brian Neal Park, Alexandria, VA (US); Jeffrey L. Park, Alexandria, VA (US); Marco C. Mason, Louisville, KY (US)

Correspondence Address: Jeremy Branson, 7313 Scarborough St., Springfield, VA, 22153, US

(21) Appl. No.: 10/261,105

(22) Filed: Oct. 1, 2002

(51) Int. Cl. H05B 6/64

(52) U.S. Cl. 219/679

(57) ABSTRACT

A device that converts the available energy inside a microwave oven into energy of a different form is described. The invention serves as a purpose of providing a novelty or indicating effect stemming from the power in a microwave oven.

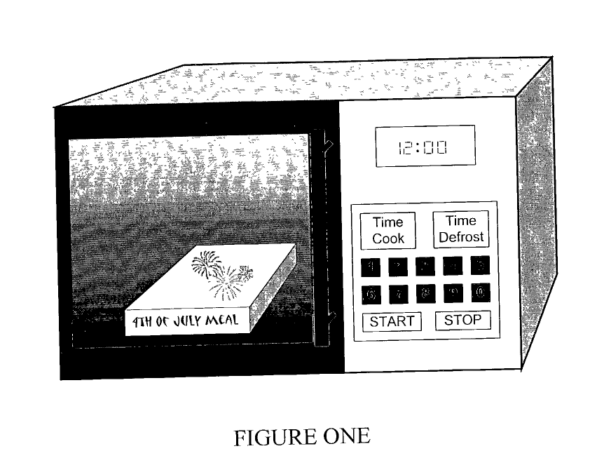

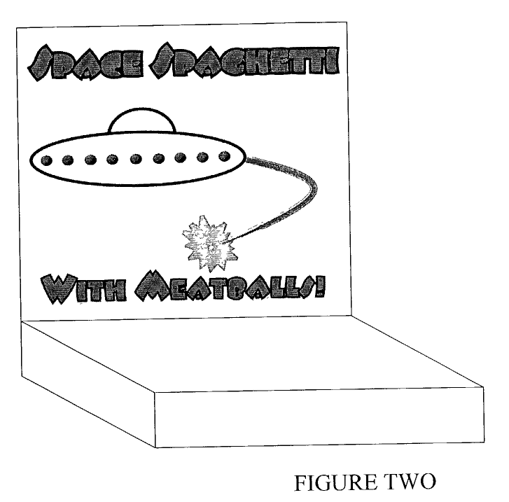

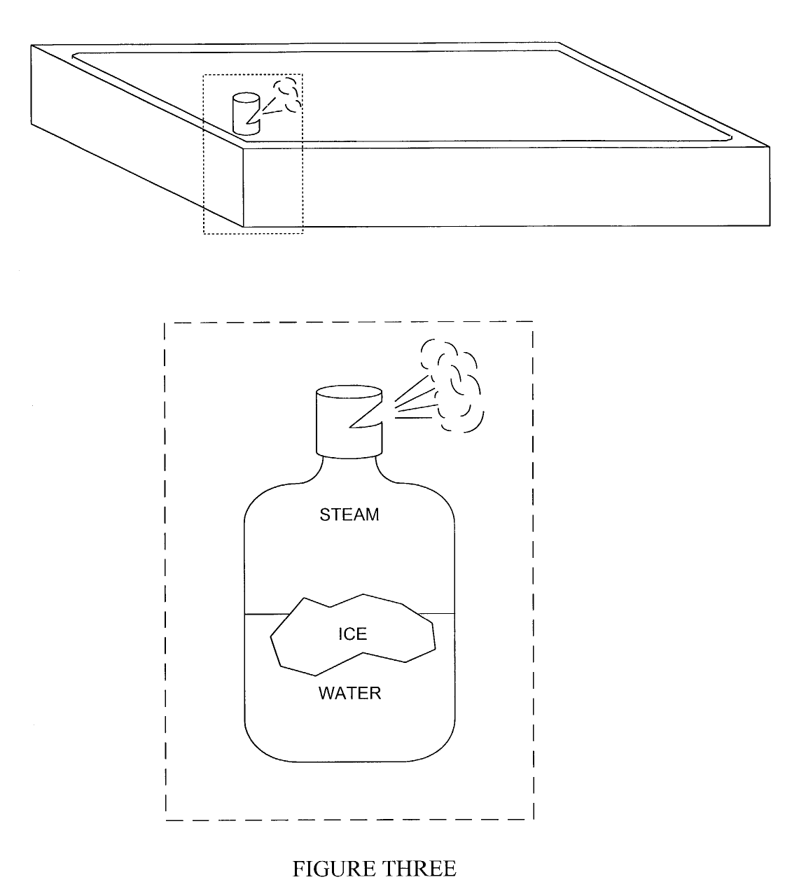

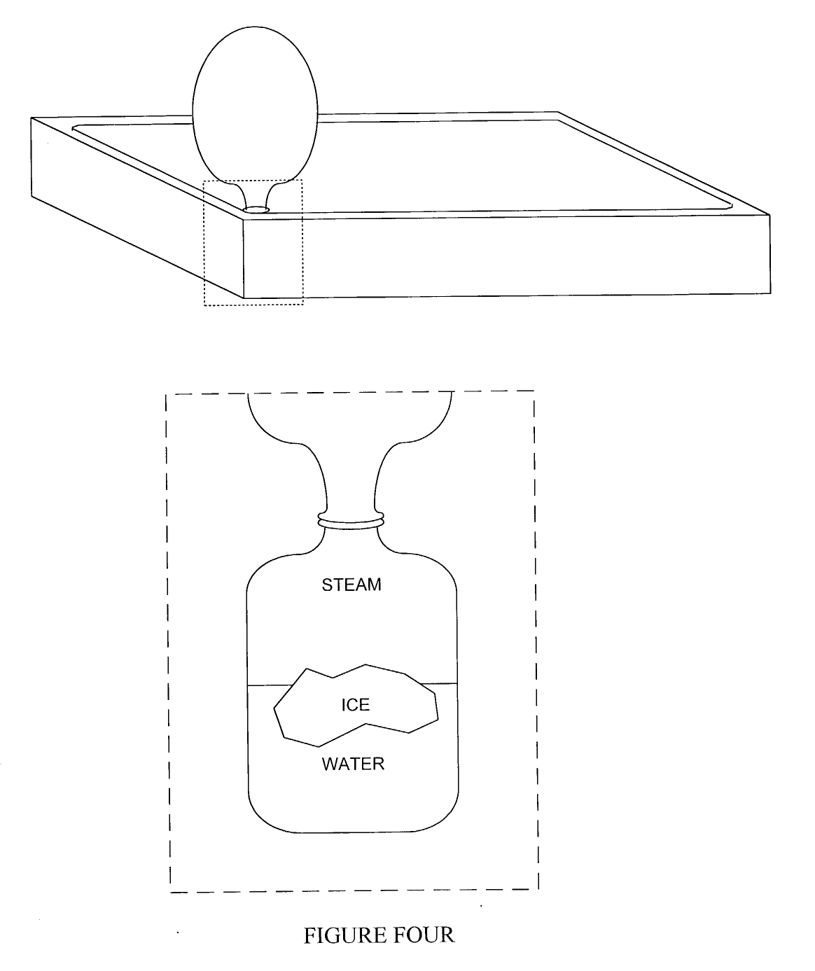

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### REFERENCES

U.S. Patent Documents:

| | | |
|---|---|---|
| 4678882 | July 1987 | Bohrer |
| 4888459 | December 1989 | Keefer |
| 4914748 | April 1990 | Schlotter |
| 5081330 | January 1992 | Brandberg |
| 5180598 | January 1993 | Jozefowicz |
| 5278378 | January 1994 | Beckett |
| 5294764 | March 1994 | Mass |
| 5820437 | October 1998 | Coleman |

### BACKGROUND OF THE INVENTION

1. Field of Invention

This invention relates generally to the field of microwave ovens and to the fields of novelty devices and measuring or indicating devices; more particularity it relates to the field of energy conversion, specifically the conversion of strong microwave fields into other forms of energy including light and sound.

2. Background Art

Various inventions have been made relating to the use of microwave oven devices.

The use of materials that interact with the energy available in microwave ovens are well established and in wide use. The energy is generally used to cook food. As an example, in U.S. Pat. No. 4,678,882, Bohrer, et al. illustrates the use of a package coated with a microwave interactive material adding heat to particulate food items such as popcorn kernels. In this example, the energy is converted to heat to aid in cooking food. Similarly, Keefer describes in U.S. Pat. No. 4,888,459 a container with dielectric structure of varying properties to modify the cooking distribution.

In U.S. Pat. No. 5,081,330, Brandberg et al. describes insulation chambers that are inflated by materials heated by the microwave energy. These chambers create an insulated chamber where food is heated. These insulated chambers prevent unnecessary heat flow from the food to the microwave oven cavity. In this invention, the microwave oven is converted into pressure energy used to expand insulation chambers.

Jozefowics describes in U.S. Pat. No. 5,180,598 liquid and/or temperature activated elapsed time sensors for use as doneness indicators. In this invention, optical interference generates color effects when certain pre-specified temperatures are attained. Alternately, the transfer of liquid into indicator chambers identifies a state. Here, microwave energy is used to generate forces to mix liquids together, creating an indication device.

Beckett describes in U.S. Pat. No. 5,278,378 a microwave heating element with antenna structure. In this invention, an antenna is provided which guides the microwave energy directly to the food.

The use of food items as novelty devices are widespread and well established. Schlotter et al. in U.S. Pat. No. 4,914,748 describes a novelty flashlight and piece of candy for illumination. In this invention, a piece of candy is illuminated by a light source placed in the package providing a novelty flashlight device. In U.S. Pat. No. 5,820,437, Coleman, et al. discloses a wacky pop noisemaker. This invention is the combination of candy and a toy noisemaker.

Inventions have also been made which relate microwave ovens to the field of novelty devices. A reusable microwave popcorn container for popping and dispensing corn kernels for recreation is described by Mass in U.S. Pat. No. 5,294,764. In this invention, the popped popcorn expands a container resembling an elongated football, a spherical playball, a novelty turtle, or other novelty device.

### BRIEF SUMMARY OF THE INVENTION

It is the object of the invention to provide an energy conversion such that the energy available in a microwave oven can be used for purposes in addition to or other than cooking food.

It is also the object of the invention to provide a novelty device powered by the energy available in a microwave oven.

It is also the object of the invention to provide a means to create light, sound, or other forms of energy powered by the energy available in a microwave oven.

It is also the object of the invention to provide a means for relaying indicator or test information from inside a microwave oven to outside the oven. The energy inside a microwave oven can be converted into another form, which can be transmitted through the walls or door of the microwave oven.

### BRIEF DESCRIPTION OF THE SEVERAL VIEWS OF THE DRAWING

Figure One shows a package for a Fourth of July meal which includes a light emitting cooking in a microwave oven.

Figure Two shows a package for a kid's meal, which includes a light emitting component.

Figure Three shows a meal equipped with a steam powered whistle where the pressurized steam is powered by the microwave energy available inside the microwave oven.

Figure Four shows a meal where the pressurized steam is used to blow up a balloon.

### DETAILED DESCRIPTION OF THE INVENTION

Figure One shows this invention as applied as a novelty device. The package containing a kid's meal comprises of a material, which emits light in upon exposure to the fields in a microwave oven. Figure Two shows a similar package placed inside a microwave oven. In this embodiment, appropriately pressured bubbles of neon gas are suspended in a transparent or translucent carrier which emit light visible through the door of the microwave oven and provides a novelty visual effect.

In another embodiment, the invention is applied to form a steam-powered whistle. The microwave energy heats the water, converts it to steam, and forces it through the whistle which converts it to audible sound energy. This energy can be heard outside the oven and provides both a novelty effect and an indication that the water has been heated.

In a third embodiment, the invention is applied to a conversion of the microwave energy to blow up a balloon, thus providing both an indicator device and novelty amusement.

In a fourth embodiment, CO₂ pressurized sugar candy pops when melted.

The foregoing description of the preferred embodiment of the invention has been presented for the purposes of illustration and description. It is not intended to be exhaustive or to limit the invention to the precise form disclosed. Many modifications and variations are possible in the light of the above teaching. It is intended that the scope of the invention be limited not by this detailed description, but rather by the claims appended hereto.

What is claimed as new and desired to be secured by Letters Patent of the United States is:

1. A device comprising of an energy conversion process whose input energy is provided by a microwave oven and whose output energy can be used for a purpose other than cooking food.

2. The system as in claim 1 where said output energy is in the form of visible light.

3. The system as in claim 1 where said output energy is in the form of audible sound.

4. The system as in claim 1 where said output energy is in the form of kinetic energy

5. The system as in claim 1 where said output energy is in the form of potential energy.

6. The system as in claim 1 where said output energy is used as a novelty device.

7. The system as in claim 1 where said output energy is used as a novelty device.

8. The system as in claim 1 where said output energy is used as an indicator device.

9. The system as in claim 1 where said device comprises of bubbles of gas suspended in a carrier.

10. The system as in claim 9 where said transparent carrier is transparent.

11. The system as in claim 10 where said transparent carrier is an acrylic.

12. The system as in claim 9 where said gas is neon.

13. The system as in claim 9 where said gas is argon.
